(19) United States
(12) Patent Application Publication
(10) Pub. No.: US 2011/0244187 A1
(43) Pub. Date: Oct. 6, 2011

(54) Internal Cavity Optics

(75) Inventor: Kari J. Rinko, Helsinki (FI)

(73) Assignee: MODILIS HOLDINGS LLC, Wilmington, DE (US)

(21) Appl. No.: 13/080,581

(22) Filed: Apr. 5, 2011

Related U.S. Application Data
(60) Provisional application No. 61/282,818, filed on Apr. 6, 2010.

(51) Int. Cl. B32B 3/00; B05D 5/06; B29D 11/00

(52) U.S. Cl. 428/156; 427/162; 264/1.7

(57) ABSTRACT

This disclosure is directed to techniques to manufacture internal cavity optical patterns and to apparatuses manufactured using the manufacturing techniques. Internal cavity optical patterns include small cavities (e.g., microcavities, nanocavities, etc.) spread across a surface of a thin transparent material. The thin material may then be laminated to a second material to join the surface having the cavities with the second material and thereby enclose the cavities within the resulting combination. The internal cavities may be filled with air or another medium (e.g., a fluid, gas, or solid), which enable the cavity to redirect light in accordance with design requirements. By manufacturing the internal cavity optics in this manner, the cavities may remain free of debris that may reduce an effectiveness of the optics. In some instances, additional layers of material may be laminated together to create additional layers of the internal cavity optics.

### REFERENCE TO PROVISIONAL APPLICATION

This patent application claims the benefit and priority to U.S. Provisional Patent Application No. 61/282,818, titled, “Integral Micro-/Nano-Cavity Solution”, filed on Apr. 6, 2010, to the same inventor herein, the entire disclosure of which is incorporated by reference herein.

### BACKGROUND

Electronic displays often use a light source to shine light onto a display to improve visibility of content on the display. For example, many electronic devices use backlights that light up the display to enable a viewer to see the content on the display that would otherwise be difficult to see without the backlights. On the other hand, reflective displays may use frontlights to improve visibility of content on the displays, particularly in low light situations.

Typically, backlights and frontlights use optical features in a lightguide to direct light from a light source onto or through a display. The optical features are typically fabricated on a side of a piece of material, such as a plastic or glass plate. The grooves that make the reflective features remain exposed to elements and may collect dust or other foreign particles or may be damaged upon contact with another surface or object (such as a user's finger, etc.).

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative environment that shows an end-to-end process of manufacturing internal cavity optics for use with an electronic display.

FIG. 2 is a schematic diagram of an illustrative manufacturing apparatus to create an internal cavity optical film that includes multiple layers of material that are laminated together.

FIG. 3 is a flow diagram of an illustrative process to laminate multiple layers of film together to enclose optical cavities within the film.

FIG. 4 is a schematic diagram of illustrative internal cavity optics that may be created using the manufacturing apparatuses shown and described in FIGS. 2 and 3.

FIG. 5 is a flow diagram of an illustrative process to laminate two or more films together to create an internal cavity optical film.

FIGS. 6a-6c are schematic diagrams of various internal cavity optic solutions that may be implemented in frontlights and/or backlights for electronic displays.

FIG. 7 is a flow diagram of an illustrative end-to-end process of manufacturing the internal cavity optics.

FIG. 8 is a schematic diagram of illustrative implementations of the internal cavity optics.

FIGS. 9a-9e are schematic diagrams of illustrative backlights that employ the internal cavity optics.

FIGS. 10a and 10b are schematic diagrams of illustrative frontlights that use the internal cavity optics.

FIGS. 11a-11d are schematic diagrams of illustrative configurations of the internal cavity optics implemented on two or more layers that are laminated together.

### DETAILED DESCRIPTION

### Overview

This disclosure is directed to techniques to manufacture internal cavity optical patterns and to apparatuses manufactured using the manufacturing techniques. Internal cavity optical patterns may be manufactured using a manufacturing process such as roll-to-roll manufacturing that creates small cavities (e.g., micro-cavities, nano-cavities, etc.) across a surface of a thin material (e.g., a transparent foil, etc.). The thin material, once processed to create the cavities, may be laminated to a second material to join the surface having the cavities with the second material and thereby enclose the cavities within the resulting combination. The lamination process may fuse the materials together to effectively remove the joined surface such that the combined material appears to be formed of a single sheet of material. The internal cavities may be filled with air or another medium (e.g., a fluid, gel, gas, solid, etc.), which enable the cavity to redirect light in accordance with design requirements. By manufacturing the internal cavity optics in this manner, the cavities may be protected against contact by other parts, and thus remain free of dirt, debris, or other contamination that may reduce functionality or an effectiveness of the optics. In some instances, additional layers of material may be laminated together to create additional layers of the internal cavity optics. For example, one layer may include cavities that create a light polarizer while another layer may include other light management gratings.

The internal cavity optical patterns may be used to redirect (collimating light, distribution of light, etc.) light from a light source in some implementations to provide frontlighting or backlighting for an electronic device. As discussed herein, the internal cavity optical patterns may also be used to focus light when implemented as a lens, project collimated light as a collimated film, act as a light polarizer, and/or provide light incoupling, among other possible uses.

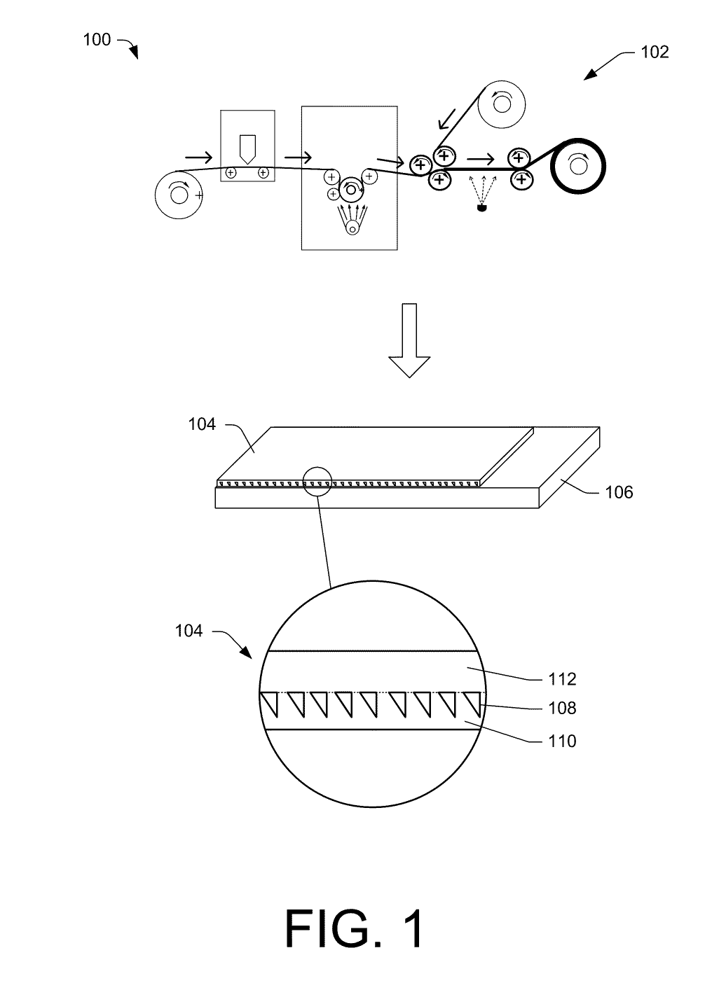

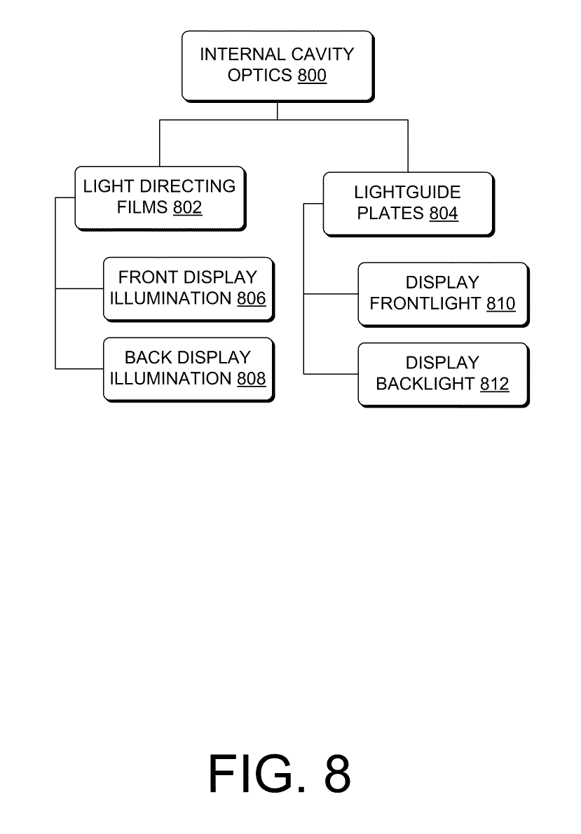

The techniques and apparatuses described herein may be implemented in a number of ways. Example implementations are provided below with reference to the following figures. FIGS. 1-7 are generally directed to the manufacture of the internal cavity optics while FIGS. 8-11d are directed to apparatuses that are created using the manufacturing techniques.

### Illustrative Manufacturing

FIG. 1 is a schematic diagram of an illustrative environment 100 that shows an end-to-end process of manufacturing internal cavity optics for use with an electronic display. A manufacturing apparatus 102 may be used to create small optical cavities on medium carrier (e.g., a thin film). The small cavities may be in the range of micrometers to nanometers and may be created in various patterns depending on design requirements and a desired utility of the optics created using the manufacturing apparatus 102. In some embodiments, the manufacturing apparatus 102 may be a roll-to-roll processing machine (or assembly); however, other manufacturing techniques and apparatus may be used to perform lithography, micro-molding, or casting on a medium carrier.

In various embodiments, the manufacturing process may include laminating two or more layers of material together such that the cavities on a surface of the medium carrier are enclosed within and internal to the resultant laminated material 104. The resultant laminated material 104 may be cut or trimmed in size to overlay a front or a back of a display 106. The resultant laminated material 104 may perform some or all functions of a frontlight or a backlight when positioned proximate the display 106.

The resultant laminated material 104 may include internal cavity optics 108, which is shown by illustrative shapes in a detailed view in FIG. 1. The internal cavity optics 108 may be formed by the manufacturing apparatus 102 (e.g., roll-to-roll embossing/imprinting, etc.). In some embodiments, the internal cavity optics 108 may be filled with air or another gas, a fluid, or a solid that enables the cavity to redirect light or otherwise modify a beam of light in accordance with intended design requirements. The use of air in the cavities may enable formation of low refractive index performance, which may be useful in the production of optics. The internal cavity optics 108 may be formed in a carrier medium 110, which may be joined by lamination to a joiner medium 112 to form the resultant laminated material 104. The seam, or surfaces, between the carrier medium 110 and the joiner medium 112 may be fused together during the lamination such that the resultant laminated material 104 appears as a single piece of material that includes the internal cavity optics 108. By using the lamination process as described herein, internal cavity optics may be created that include inverted geometry when viewed from the display side (e.g., cavities with a small opening or no opening) that may otherwise be impossible to create using imprinting, lithography or other similar techniques because of an inability to remove a tool from the cavity (e.g., inverted “v” feature) or otherwise control removal of material during manufacturing. However, these features become viable options after lamination of the two or more layers of material because the resultant laminated material 104 may be flipped over (inverted) and then applied to the display 106 because either side of the resultant laminate material may be suitable for exposure to elements (e.g., a user's finger, etc.).

In addition, the resultant laminated material 104 may include smooth and durable surfaces, which may prevent accumulation of dirt or other debris in the internal cavity optics 108. The resultant laminated material 104 may enable input of touch sensitive commands when implemented as a frontlight or otherwise protect the internal cavity optics during interaction by a user.

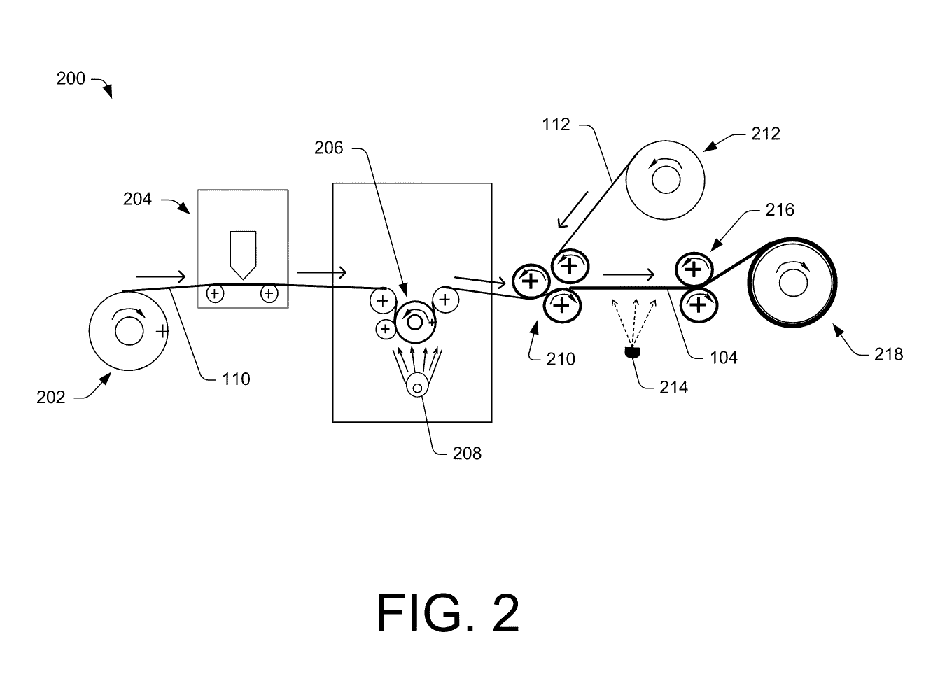

FIG. 2 is a schematic diagram of an illustrative manufacturing apparatus 200 to create an internal cavity optical film that includes multiple layers of material that are laminated together. Although other techniques and apparatuses may be used to create the internal cavity optics 108, the manufacturing apparatus 200 is discussed as a roll-to-roll manufacturing apparatus that combines at least two layers of material (e.g., the carrier medium 110 and the joiner medium 112).

The manufacturing apparatus 200 may include a roll of the carrier medium 110 that is unwound from a source roller 202 during a manufacturing process. In accordance with various embodiments, the carrier medium 110 may be between a few nanometers thick up to a few millimeters thick depending on a desired application. The carrier medium 110 may be flexible or bendable and may be formed of a polymer, elastomer, glass, ceramic, or other flexible material that may be transparent, semi-transparent, or possibly translucent.

The carrier medium 110 may pass through a coater 204 that dispenses a lacquer onto at least the surface of the carrier medium that is to receive the cavities. The lacquer may be curable by exposure to ultraviolet (UV) light (UV curable lacquer), thermal exposure (thermo curable lacquer), moisture (moisture curable lacquer), electron beams (electron curable lacquer), or by other techniques. The carrier medium 110 may then pass across a replication cylinder 206 (or other type of shaped stamp) that contains patterns (ridges, features, etc.) that form (emboss) the carrier medium to create the cavities when the carrier medium passes over (or under) the replication cylinder. In accordance with some embodiments, the replication cylinder 206 may include patterns on the scale of a few nanometers to a few micrometers in width and/or height, which after interaction with the carrier medium 110, create cavities of similar dimensions.

During and/or after the embossing, the carrier medium 110 may be cured using a curing process 208 to cure the lacquer, which now may contain the cavities formed using the patterns of the replication cylinder 206. The curing process may include exposing the lacquer to UV light, thermal waves, moisture, electron beams, or any combination thereof, either sequentially or in simultaneously. The carrier medium 110 may then pass through a main drive 210 that pulls the carrier medium from the source roller 202.

Meanwhile, the joiner medium 112 may be dispensed from another roller 212 and may be joined (overlapped) with the carrier medium to cover over the cavities. In some embodiments, the joiner medium 112 may be a thicker medium than the carrier medium 110. For example, the joiner medium may be formed of plastic or other material. In various embodiments the joiner medium 112 may be formed of the same material as the carrier medium 110, but may have a different thickness. The joiner medium 112 may be laminated to the carrier medium 110 by another curing process 214. As discussed above, the lamination may fuse the materials together to effectively remove a seam between the materials. The resultant laminated material 104 may pass through another set of drive rollers 216 and then be collected at a depository roller 218.

Although the manufacturing apparatus 200 only shows creation of the internal cavity optics on a single carrier medium, the manufacturing device may include additional source rolls and replication cylinders/stamps to create other layers that, when processed through the replication cylinders, include the cavities. These additional layers may then be laminated together to create a resultant laminated material formed of multiple layers, which may include various layers of internal cavity optics. For example, one layer of the internal cavity optics may act as a light polarizer while another layer may include internal cavity optics as surface relief patterns or light management gratings that redirect light onto a display.

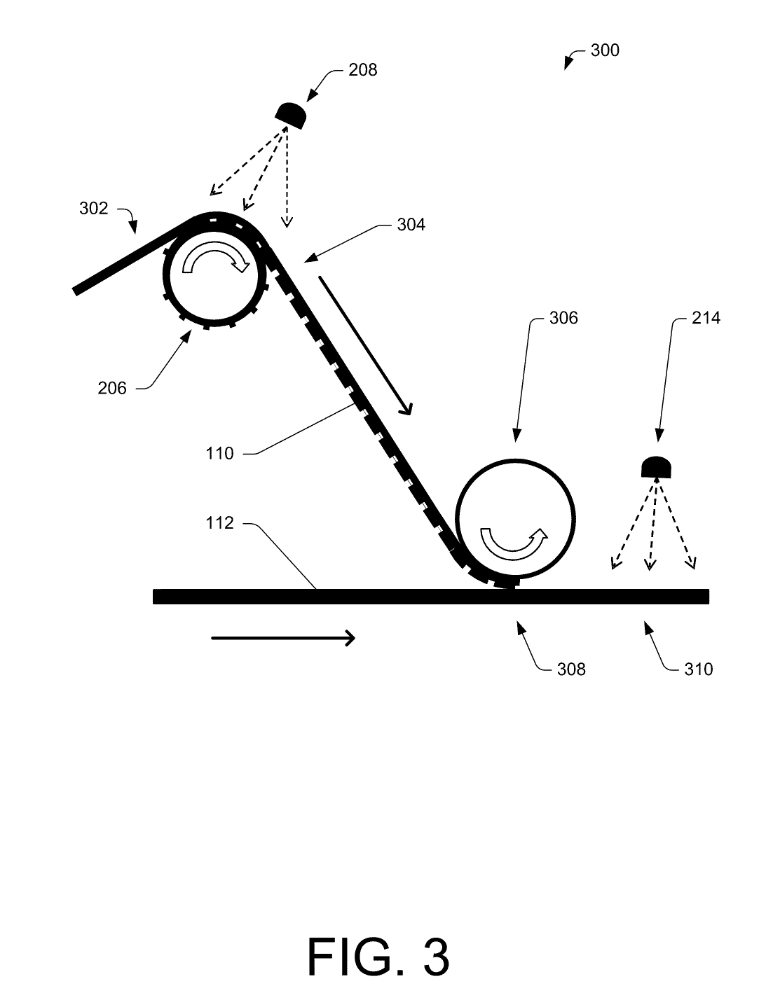

FIG. 3 is a flow diagram of an illustrative process 300 to laminate multiple layers of film together to enclose optical cavities within the film. The process shows the carrier film 110 prior to formation of the cavities at 302. After the carrier film 110 passes over the replication cylinder 206 and is exposed to the curing process 208 during a pre-curing process, the carrier medium emerges at 304 with the cavities.

The carrier medium 110 may then be joined with the joiner medium 112 at a lamination cylinder 306, which may laminate the carrier medium 110 to the joiner medium 112 at 308. Finally, the resulting laminated material may be exposed to the other curing process 214 during a post curing process at 310.

The process 300 may be arranged to enable application of the carrier medium 110 on a relatively stiff joiner medium 112, which may be processed while remaining relatively flat or planar (as shown in FIG. 3). However, other configurations of the manufacturing apparatus 200 and/or the process 300 may be used to orient, process, handle, or otherwise manipulate the raw materials prior to or during the manufacturing to create the resultant laminated material 104 that conforms with design requirements.

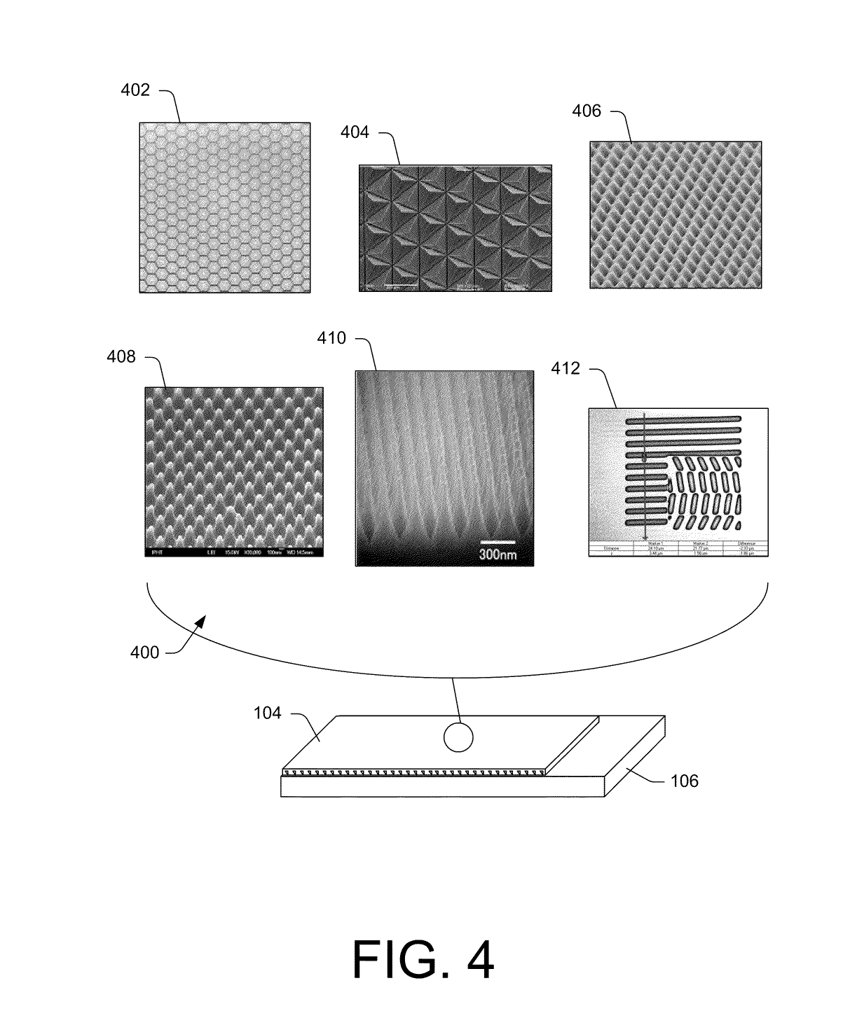

FIG. 4 shows a schematic diagram of illustrative internal cavity optics 400 that may be created using the manufacturing apparatuses and processes shown and described in FIGS. 2 and 3. The illustrative cavity optics 400 may include geometric profiles, (shown in a first sample 402 and a second sample 404), a depression profile (shown in a third sample 406, a fourth sample 408, and a fifth sample 410), or other variations, such as a multi-pattern sample 412. Each configuration or sample may include specifically shaped and oriented cavities to redirect or otherwise modify the transmission of light from a light source in accordance with design requirements.

In accordance with various embodiments, small patterns such as gratings, binary, blazed, slanted and trapezoid shapes may be formed by the manufacturing apparatus to create internal cavity optics having one or more of these patterns. The patterns may be discrete patterns, such as grating pixels, small recesses or continuous pattern forms, elongated recesses and channels, and/or any kind of two or three dimensional (2D, 3D) shapes. The pattern may include at least a small amount of flat surface on a contact surface to be laminated to enable proper adhesion and light propagation to the joiner medium. If there is no contact surface, the real air cavity may not be maintainable in some instances. For example, a round micro-lens surface may not form cavities that can withstand repetitive use. However, those cavities may be filled with a pressurized gas, a fluid or a solid, particularly when the cavities are created as long channels.

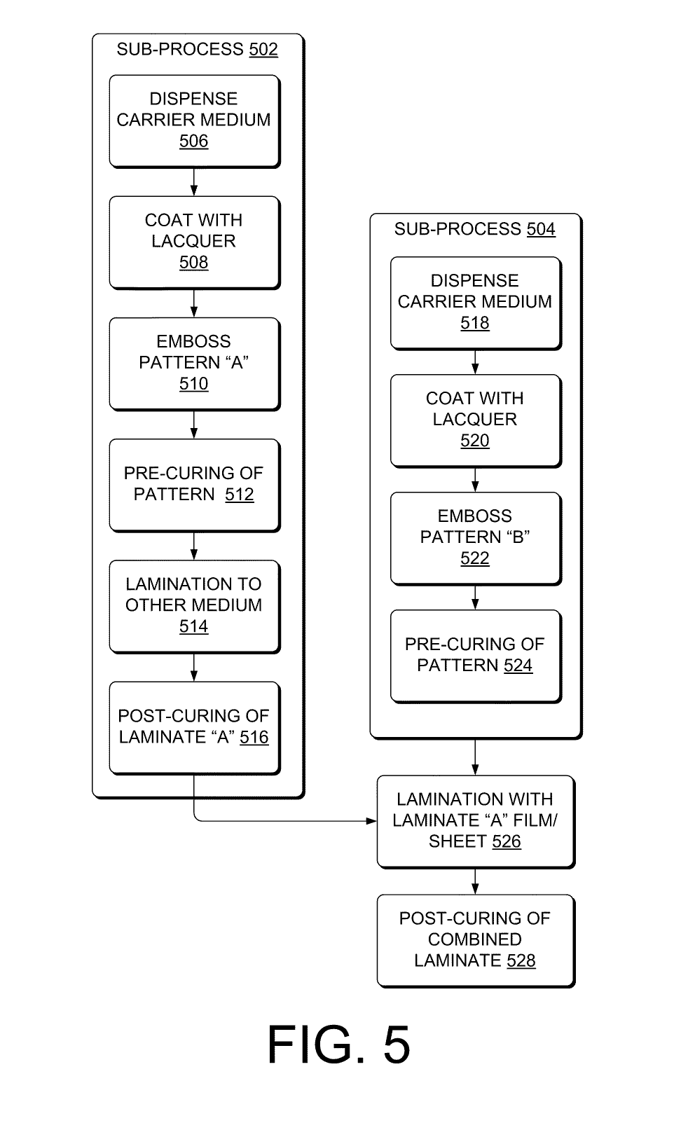

FIG. 5 is a flow diagram of an illustrative process 500 to laminate two or more films together to create an internal cavity optical film. The operations described in the process 500 may be performed using the manufacturing apparatus 200. The process 500 includes a first sub-process 502 and a second sub-process 504. The first and second sub-processes may be performed independently or in parallel (simultaneous or nearly simultaneous). In some embodiments, the process 500 may only include the sub-process 502 and may refrain from performing some or all of the operations in the second sub-process 504. Additional sub-processes may also be included in the process 500, which may perform the same or similar operations as described with respect to the first or second sub-processes.

In the first sub-process 502, at 506, the source roll 202 may dispense or unwind the carrier medium 110 (e.g., a thin foil, etc.). At 508, the carrier medium 110 may be coated with a lacquer. For example, the coater 204 may spray the carrier medium 110 with the lacquer, the carrier medium 110 may be immersed, or partially immersed, in the lacquer, or the lacquer may be applied to the carrier medium by other techniques.

At 510, the replication cylinder 206 may emboss the carrier medium 110 to create a pattern “A”, which may be an optical pattern for a polarizer, an incoupling/outcoupling pattern, a light management grating pattern, a surface relief pattern, a lens pattern, or another type of optical feature or pattern.

At 512, the curing process 208 may perform a pre-curing of the pattern “A” created by the embossing via the replication cylinder 206.

At 514, a side of the carrier medium 110 that includes the pattern may be joined with the joiner medium 112. The carrier medium 110 may then be laminated to the joiner medium 112 at 514.

At 516, the other curing process 214 may emit UV light (or other curing process) onto the carrier medium 110 and joiner medium 112, which is collectively referred to as laminate “A” (i.e., the resultant laminated material 104).

The process 500 may end at 516 in embodiments where the resultant laminated material 104 only includes two layers. However, additional layers, and therefore additional optical patterns of internal cavity optics may be added to the laminate “A” via the second sub-process 504 as explained below. The second sub-process 504 may be performed prior to, after, or concurrently with the operations of the first sub-process 502.

At 518, another source roller (e.g., the roller 212) may dispense or unwind another carrier medium that may be the same as the carrier medium 110 used in the sub-process 502 or may be formed of another material and/or thickness. At 520, a coater (e.g., the coater 204) may coat the carrier medium with a lacquer. At 522, a replication cylinder (e.g., the replication cylinder 206) may emboss the carrier medium to create a pattern “B”, which may be a different optical pattern than the pattern “A”. At 524, the curing process 208 may perform a pre-curing of the pattern “B” created by the embossing.

In some embodiments, some of the operations in the second sub-process 504 may be performed by the same or similar components that perform the operations of the first sub-process 502. In various embodiments, the manufacturing apparatus may include dedicated hardware to concurrently perform the first and second sub-processes 502, 504.

At 526, the carrier medium with the pattern “B” may be joined with the laminate “A” such that a side of the carrier medium with the pattern “B” is joined with and adjacent to a side of the laminate “A” to cover the cavities that form the pattern “B”. Thus, the cavities in that form both the pattern “A” and the pattern “B” are internal cavities after lamination. The carrier mediums may be laminated together at 516 to create a single material (e.g., the resultant laminate material 104 having multiple layers of internal cavity optics). At 528, the resultant laminate material 104 may undergo a post-curing process to cure the laminate.

In some embodiments, additional sub-processes that are similar to the second sub-process 504 may be performed to add additional layers, and thus additional layers of internal cavity optics to the resultant laminate material 104.

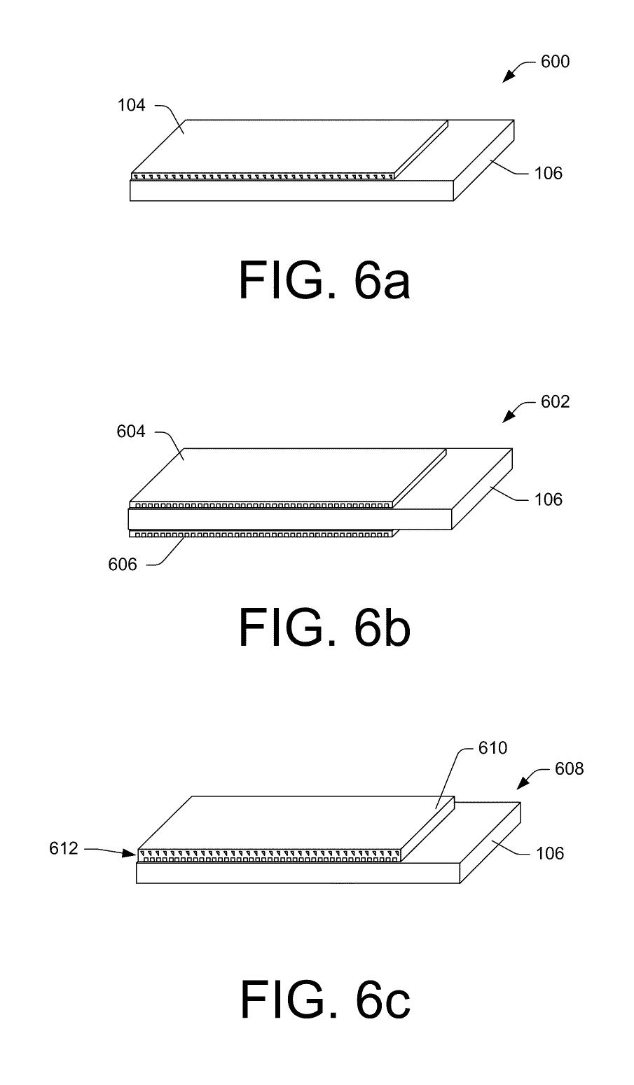

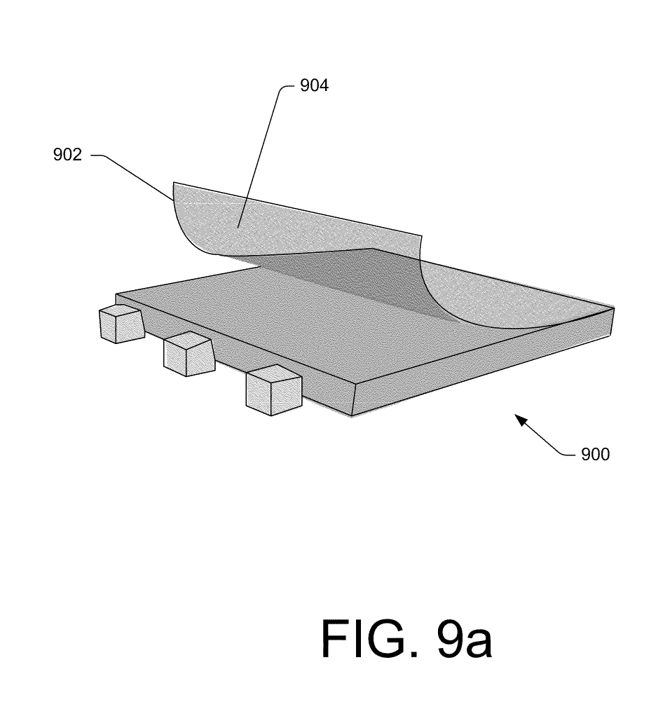

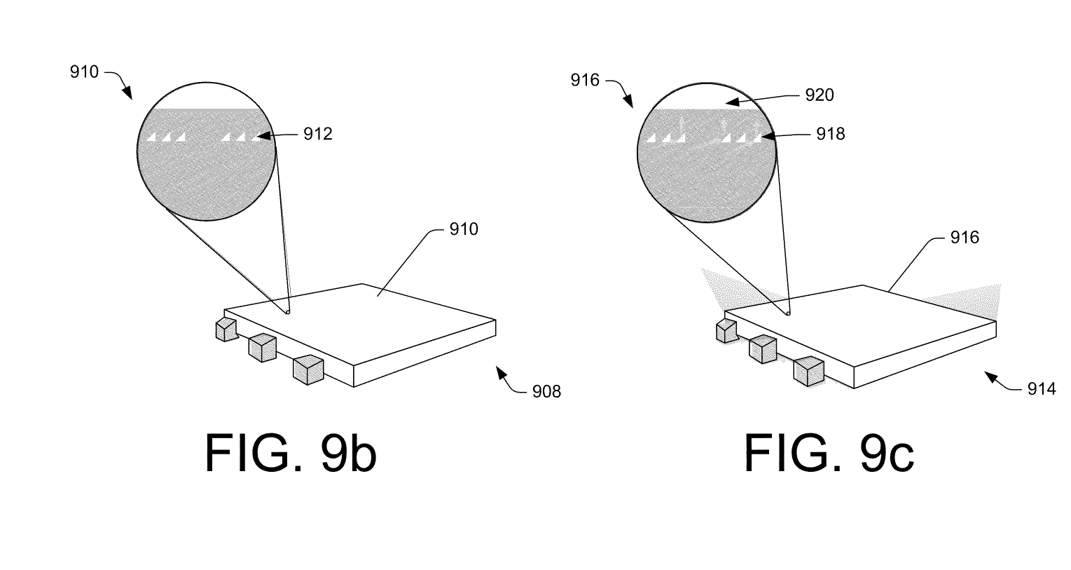

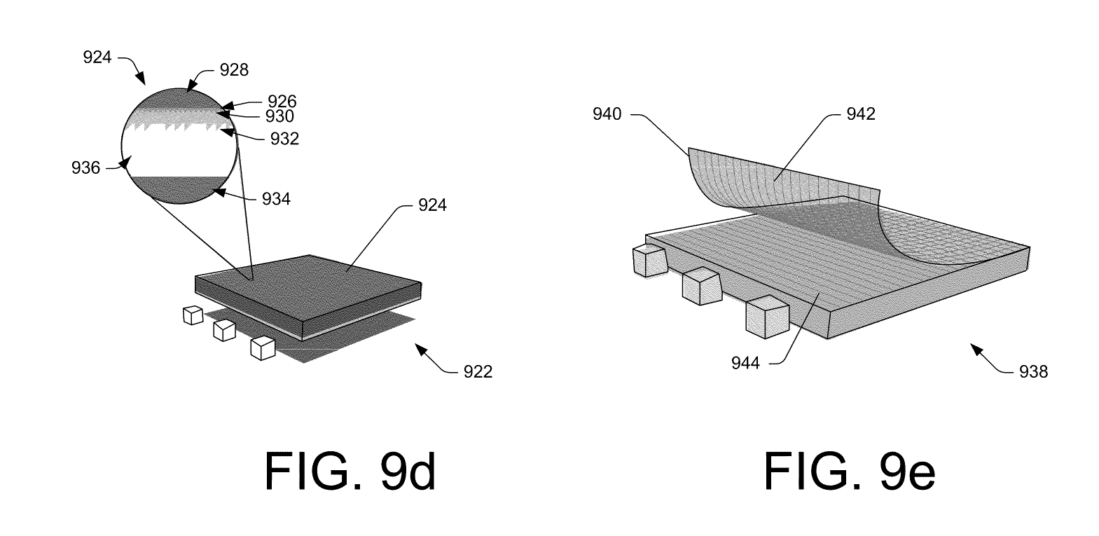

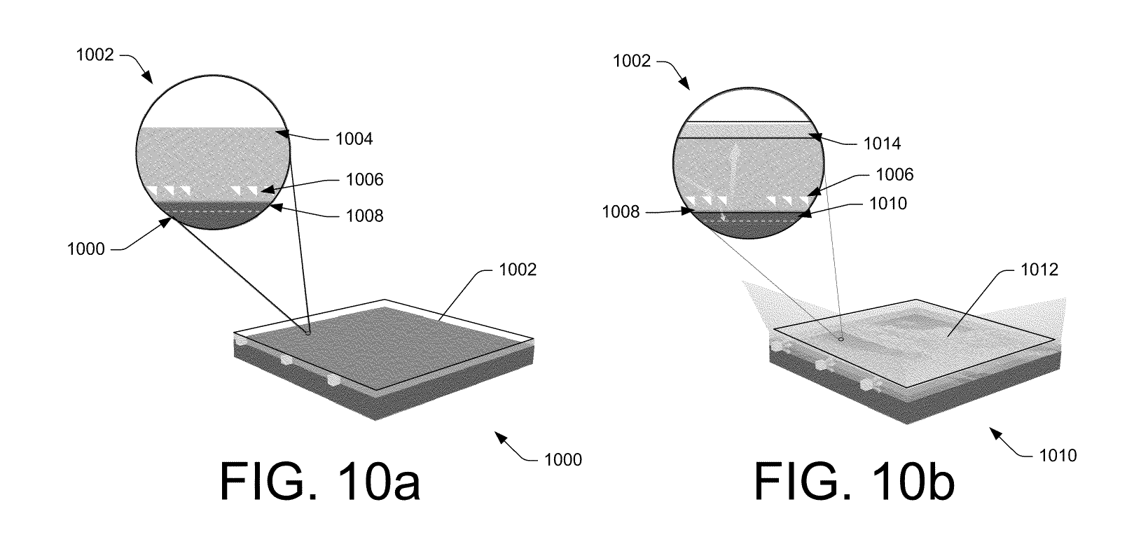

FIGS. 6a-6c show schematic diagrams of various internal cavity optic solutions that may be implemented in frontlights and/or backlights for electronic displays. FIG. 6a shows an assembly 600 that includes the display 106 having a resultant laminate material 104 having a single layer of internal cavity optics that are applied to a front side of the display. For example, the resultant laminate material 104 may be used in this configuration as a frontlight. Additional details of the frontlight configuration are discussed below with reference to FIGS. 10a and 10b. The resultant laminate material may alternatively be used in this configuration as a backlight, which is described with additional details with reference to FIGS. 9a-9e.

FIG. 6b shows an assembly 602 that includes the display 106 having a first resultant laminate material 604 having a layer of internal cavity optics and that are applied to a front side of the display 106 and a second resultant laminate material 606 having a layer of internal cavity optics that are applied to a back side of the display 106.

FIG. 6c shows an assembly 608 that includes the display 106 having a multi-layer resultant laminate material 610 having multiple layers of internal cavity optics 612 and that are applied to a side of the display 106.

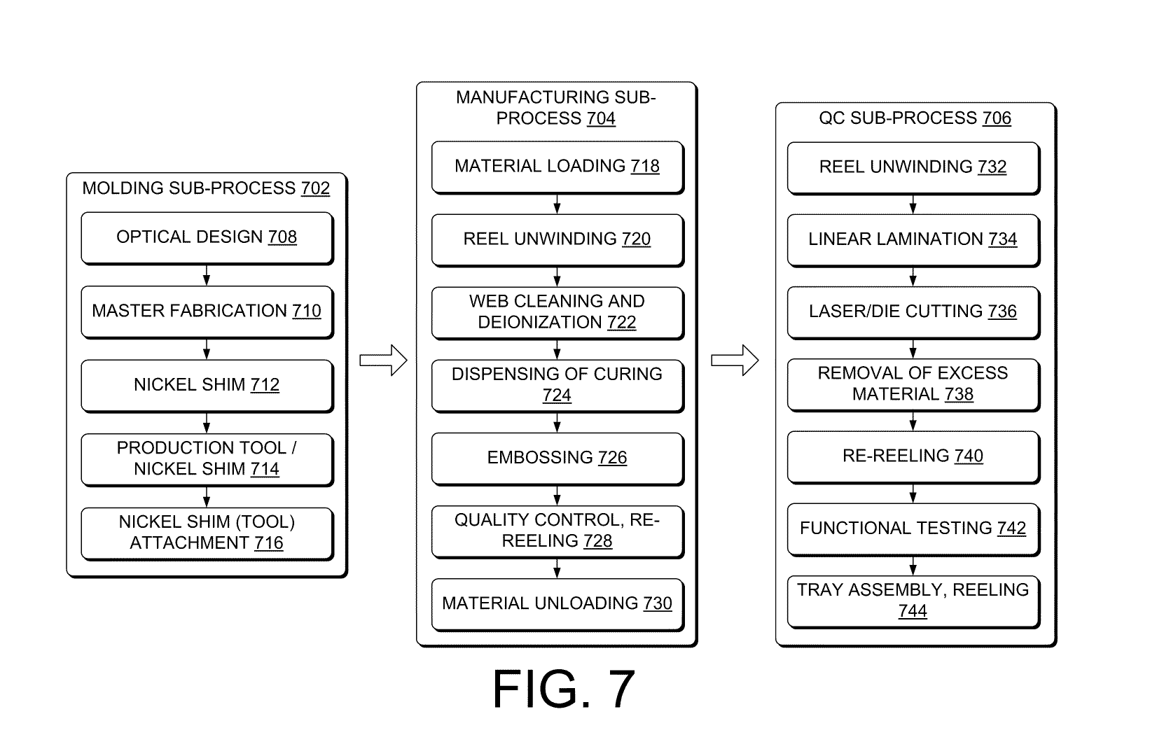

FIG. 7 is a flow diagram of an illustrative end-to-end process 700 of manufacturing the internal cavity optics. The process 700 includes three sub-processes. A first sub-process 702 describes molding to create at least a portion of the manufacturing apparatus 102, a second sub-process 704 describes use the manufacturing apparatus 102, and a third sub-process 706 describes material processing and quality control processing of the resultant laminated material 104. Each of the sub-processes is described in turn.

In accordance with various embodiments, the first sub-process 702 may include an optical design at 708 and master fabrication at 710. A nickel shim may be created at 712, which may be used to, or implemented as, a production tool at 714. The nickel shim may be attached to the manufacturing apparatus at 716 to enable the embossing of the carrier medium 110.

In some embodiments, a pre-mastering pattern may be completed by micro machining, lithography, imprinting, embossing or other suitable techniques. The pre-mastering pattern can be replicated by electroforming, casting, or molding. The formed nickel, plastic master plate, cast material plate, or molded plate may be formed to contain a plurality of micro-reliefs that create a pattern on the surface of the plate. The pattern may include one or more of small grooves, recesses, dots, pixels, and so forth. In some embodiments, the micro-reliefs (or non-reliefs) are negative relief patterns that may be suitable for an inkjet printing modulation process. This modulation process may be based on a profile filling technique in which an existing groove, recess, dot, pixel, etc. is completely filled with inkjet/printed material. This material may be dispensed in the master plate by forming small pico (10⁻¹²) drops in order to fill and “hide” the existing patterns. The techniques may be suitable to complete a filling factor modulation on the surface (e.g., in a lightguide application, etc.). However, these techniques may be suitable for many other applications as well, and not only for completing filling factors. It may also be used to design different discrete figures, icons, forms and shapes, which enable creation of a low cost optical designing process that is relatively fast, flexible, and easy to use. These techniques may be particular well adapted for large surface areas (e.g., a large screen monitor or television, etc.).

The filling material (e.g., ink, etc.) may be transparent and optically clear, which may have the same or a similar refractive index as the plate material. This may enable real functional testing. In some embodiments, colored ink may be used. However, the use of colored ink may require a replication process in order to obtain functional optical testing of a completed part.

A drop size and material viscosity are also important considerations in terms of controlled and high quality filling. If a viscosity is too low, the drop may flow for a large area and may travel along a bottom of a groove, thus making it difficult to completely fill a structure. If the viscosity is too high, the drop size may be larger, but the form is more compact and may not flow on the groove as much as desired.

A low viscous material, which guarantees small drop size, may be a good tradeoff When utilizing a small pattern, discrete grooves, recesses, dots or pixels, the drop may be used to fill only preferred patterns in a preferred location. Thus, a pre-master structure is preferable patterned with small pixels or discrete profiles.

In accordance with some embodiments, the second sub-process 704 may include loading the carrier medium 110 and joiner medium 112 at 718. At 720, the manufacturing apparatus 102 may unwind the carrier medium 110, which may undergo web cleaning and deionization at 722. At 724, the carrier medium may be treated with lacquer. At 726, the carrier medium 110 may be embossed by replication cylinder 206 and pre-cured with the light. At 728, the carrier medium, once embossed, may be inspected for quality control (QC) purposes and re-reeled (rolled for storage). At 730, the embossed carrier medium may be unloaded from the manufacturing apparatus 102. In some embodiments, the second sub-process 704 may include the lamination as described in the operations 514 and 516 of the first sub-process 502 shown in FIG. 5.

In accordance with various embodiments, the third sub-process 706 may include unwinding the resultant laminated material that includes the internal cavity optics at 732. At 734, the resultant laminated material may be laminated to a side of a display, a lightguide, or other feature. At 736, the resultant laminated material may be cut using laser cutting, die cutting, or other cutting techniques. For example, excess material may be cut from edges of a display or lightguide after the material is attached to the display. At 738, excess material may be removed, such as the material cut in the operation 736. At 740, excess material may be re-reeled and stored for later use.

At 742, the material may be tested for quality control purposes. For example, the material may be deployed as a frontlight or backlight with an electronic display and then measurements may be taken to determine whether the material is suitable for further deployment. At 744, a tray may be assembled.

### Illustrative Optics

FIG. 8 is a schematic diagram of illustrative implementations of the internal cavity optics 800 that includes variations arranged in a hierarchy. The internal cavity optics 800 may be subdivided into light directing films 802 and lightguide plates 804. The light directing films 802 may be thin films that are laminated or otherwise attached or configured adjacent to a display or lightguide to direct light from a light source in accordance with design requirements. For example, the light from a light source may be directed through the films that include surface relief forms, light management gratings, a polarizer, or other optical features that manipulate the light and/or re-direct the light onto or through individual pixels of a display. As shown in FIG. 8, the light directing films 802 may include front display illumination 806 and back display illumination 808 as different configurations of the light directing films 802.

The internal cavity optics 800 may also be deployed as the lightguide plates 804. The lightguide plates 804 may direct light from a light source to disperse the light across a surface of the display. For example, the lightguide plates 804 may include surface relief forms deployed as the internal cavity optics. The lightguide plates 804 may be configured as a display frontlight 810 and/or as a display backlight 812. Each of the configurations of the internal cavity optics 800 will be described in further detail with reference to the following figures.

### Illustrative Backlight Configurations

FIGS. 9a-9e are schematic diagrams of illustrative backlights that use the internal cavity optics. Lightguides may be produced from bulk plates or films, which may have laminated film on a surface (one side or both sides). The film may include optical patterns, which outcouple the light for distribution. Pre-formed films may be laminated, which include the internal cavities on the laminated surfaces. These formed cavities may comprise air (or another gas) and thus may provide low refractive index properties and very effective outcoupling and light managing features.

FIG. 9a shows an illustrative transparent lightguide 900 with laminated coupling optics. A resultant laminated material 902 may include coupling patterns 904. The resultant laminated material 902 may be laminated to the lightguide via a rolling process or other suitable process (adhesives, etc.).

FIG. 9b shows an illustrative transparent lightguide 908 that includes internal cavity optics. The resultant laminated material 910 may include internal cavity optics 912 in a profile of internal microcavity coupling optics or nanocavity coupling optics. In some embodiments, the internal cavity optics 912 may be filled with air. However, other fluids, gases, or solids may be used to fill the cavities. In some embodiments, the resultant laminated material 910 may include at least one layer formed of glass or plastic, which may be the joiner medium 112 and more rigid than the carrier medium 110 that is embossed with the cavity optics prior to a lamination of the mediums to form the resultant laminated material 910 having the internal cavity optics 912.

FIG. 9c shows an illustrative transparent lightguide 914 that includes internal cavity optics. A resultant laminated material 916 may include a first layer 918 of internal cavity optics to couple and/or collimate light beams and a second layer 920 of cavity optics that act as a polarizer. In some embodiments, the polarizer may use a wire grid profile. The polarizer may be implemented as internal cavity optics in the second layer 920 or on a surface of the resultant laminated material.

In various embodiments, the top laminated film (second layer 920) may contain integral light outcoupling optics and polarization gratings (wire grid or other new grating solution) on the top of the film. This may be a beneficial solution for liquid crystal display (LCD) technologies because narrow light outcoupling and distribution in on-axis may be a most suitable direction for top polarization gratings and provides a high degree of polarization, which may not be based on light circulation. This may provide higher efficiency of the polarized light. This film solution can be further laminated directly to the display backplate together with lightguide plate.

FIG. 9d shows an illustrative display 922 that includes internal cavity optics configured to create a hollow backlight with internal cavity coupling optics (e.g., integrated wire grid polarizer, etc.). A resultant laminated material 924 may include an adhesive layer 926 on a backplate 928 of the display 922. An integrated wire grid polarizer 930, coated binary profile may be applied adjacent to the adhesive layer 926. A laminated film 932 with a profile of coupling optics may be applied adjacent to the integrated wire grid polarizer 930. A reflector 934 may be separated from the laminated film 932 by a cavity 936 filled with air, another gas, a fluid, or a solid.

FIG. 9e shows an illustrative lightguide 938 that includes internal cavity optics. A resultant laminated material 940 may include coupling patterns 942 with a vertical contact grid while the lightguide 938 may include a horizontal contact grid 944. The lightguide 938, with the resultant laminated material 940, may be configured as active cavity coupling optics by a passive matrix grid formed with the coupling patterns 942 and the horizontal contact grid 944.

As shown in FIG. 9e, the backlight may be formed by a hollow type of lightguide, in which the air is a medium carrier and grating pattern (positive relief) is coupling light directly. This type of grating film can be laminated on another medium carrier such as plastic or glass plate. In some embodiments, the grating film may be directly laminated on the backplate of the display. This integrated solution may enable production of a thinner lightguide that previous lightguides.

In some embodiments, polarizer gratings may be applied on a side of the film, which may be on a contact of a backplate of a display. The ordering of layers may be arranged as 1) light directional coupling, 2) polarization, and 3) display transmission or other variations of this combination.

This solution may effectively mix light emitting diode (LED) light if there are different color ranks. For a larger lightguide solution, there may be little or no light absorption of medium catTier (like plastic has) and a shift of a color coordinate of the white light. If coupling patterns are based on linear orientation, pre-collimation optics for the LED sources may be beneficial.

The above discussion is primarily based on edge lighting solutions. However, the described hollow lightguide can also be created with several LED rows under the film. Then LEDs are collimated or reflected by 3D reflectors in order to achieve uniformity. This type of coupling can be utilized also for light incoupling.

In some embodiments, lightguides can be made with the optical film described above, which has active/passive matrix (electrical, such as TFT technology) for surface contact control, which may also be based on cavity optics. This electrically controlled system may provide outcoupling in the designated location (via software) at preferred time. Software may control the uniformity and density of coupling contact factors in order to control uniformity and brightness. Electrical contacts can be based on static electricity or other viable solutions. This solution is suitable for an LED display (e.g., television, etc.) and/or a light panel.

In accordance with some embodiments, infrared (IR) based coupling may be achieved using the internal cavity optics with visible light. Dual layers may be utilized, such as an inner layer for visible light coupling and an outer layer for IR light coupling (air gap). Low refractive index coating/film for IR coupling may be utilized, which has lower thickness than IR light. Thus, the visible light may be unable to “see” IR patterns and only IR light can see them because of a thickness of the layer. This is one suitable solution for an IR-based touch screen. A touch screen circuit (e.g., with ITO or carbon nanotubes) can be printed on a top surface, which may create a more integrated solution. This may be used for backlight and/or frontlight applications.

### Illustrative Frontlight Configurations

FIGS. 10a and 10b are schematic diagrams of illustrative frontlights that use the internal cavity optics. The frontlight may be a separate element on the top of a display. Frontlight solutions often have problems with contrast and reflection between surfaces caused by stray light. Use of a laminated frontlight with a lower refractive index material between the lightguide and display substrate may improve contrast and reduce reflections between the surfaces.

FIG. 10a shows an illustrative display 1000 that includes internal cavity optics. A resultant laminated material 1002 may include a plain surface 1004, which protects internal cavity optics 1006 from contamination, debris, or other matter that may impair the optical quality of the resultant laminated material 1002. The resultant laminated material 1002 may be attached to the display 1000 via an adhesive layer 1008 on the top plate of the display 1000. The adhesive layer 1008 may be adjacent to the carrier medium 110 that includes the internal cavity optics 1006 while the plain surface 1004 may be part of the joiner medium 112, which may be formed of a plastic or glass material or other relatively sturdy material that resists damage and protects the internal cavity optics 1006.

In some embodiments, optical coupling patterns may be placed on the backplate. Normally these patterns are on the top surface of the display, which can lower a contrast especially when there is a larger amount of the stray light. When the patterns are placed close to the real display image, the visibility of the patterns is lessened, which enables utilization of higher density structures and even larger structures and profiles without sacrificing visibility. The bottom pattern may be integrated by lamination on the display or image surface. Bottom patterns may minimize stray light while enable use of other functional patterns or layers on the top of the frontlight, such as anti-reflection pattern, anti-clear pattern, touch screen element (circuits, layers), other optical patterns/films (polarizer gratings), and so forth. A plain top surface is may be appropriate for “open” solutions where users interact with the display using touch commands.

Optical patterns for the frontlight may be created using small optical patterns (nano/micro scale) such as gratings. Binary gratings are effective for a larger viewing angle and blazed gratings are often effective for a narrower viewing angle. A hybrid grating solution that combines these solutions may also be utilized.

Electronic paper displays, in particular, rely on use of adequate frontlighting, which may be provided by frontlights that include internal cavity optics. These types of displays, in which the image surface is very close to the top plate/film, function well with binary gratings or other invisible pattern frontlights. Optical patterns may be made to be practically invisible to humans by lamination of film/adhesive film, which completely penetrates in the grating profile.

Light incoupling is a consideration when a laminated frontlight is used. Normally lamination forms brighter spots (hot spots) in an area in the vicinity of light source. This can be avoided or minimized using a tape strip or printed strip on the front of light source. Also some diffusing optics patterns can be utilized. These solutions avoid the hot spot and provide more uniform illumination from the light source or light sources.

FIG. 10b shows an illustrative display 1010 that includes internal cavity optics. A resultant laminated material 1012 may include the internal cavity optics 1006 and an adhesive layer 1008. In addition, the resultant laminated material 1012 may include a surface laminated touch panel 1114 to configure the frontlight as a touch integrated frontlight solution. The frontlight structure may be formed with a light outcoupling structure and a touch screen circuit or IR coupling structure in a same lightguide. Structures can be placed on the same side or different sides of the lightguide. The visible light may have its own outcoupling pattern and the IR coupling pattern and/or the touch circuit may be separated or isolated by an individually placed layer, which may be implemented using a side laminated layer or two different laminated layers (one side or both sides). In some embodiments, white light may be utilized for the touch screen solution. This is based on optical signal strengthening using coupling optics. The touch screen solutions may be suitable for electronic book reader devices, mobile phones, and/or other consumer electronics that include a display.

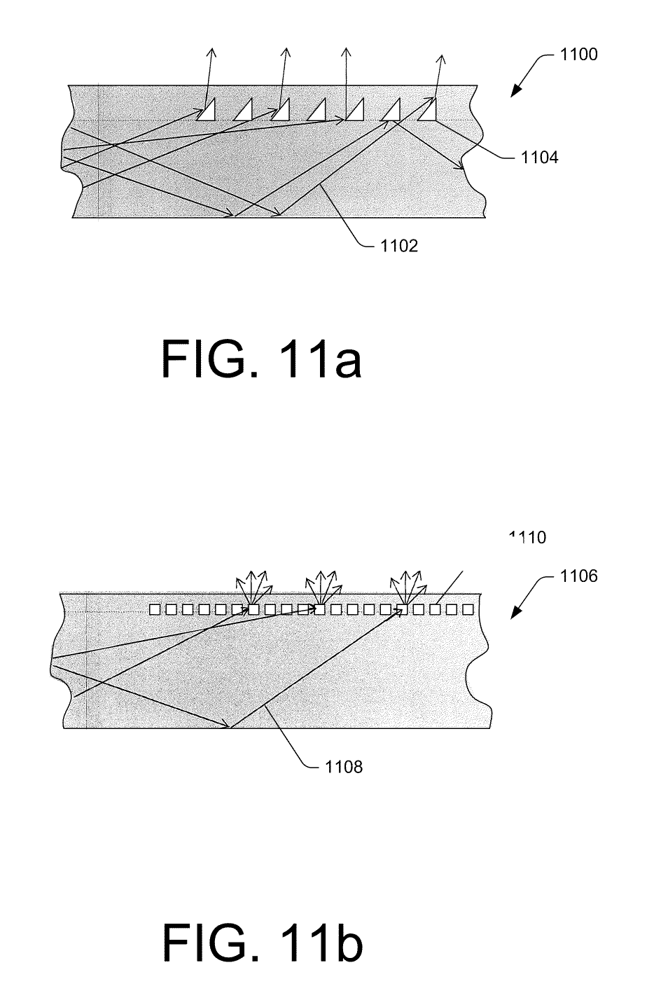

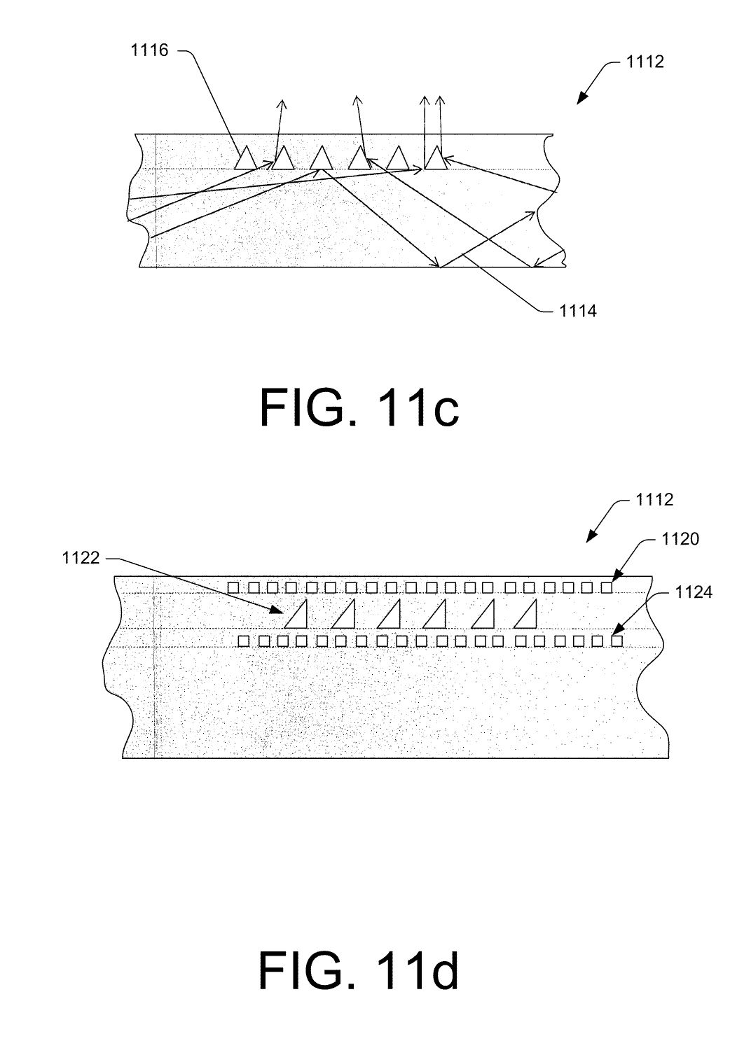

FIGS. 11a-11d are schematic diagrams of illustrative configurations of the internal cavity optics implemented on two or more layers that are laminated together to create a resultant laminated material.

FIG. 11a shows a side view of an illustrative resultant laminated material 1100 that includes example rays of light 1102 being redirected by internal cavity optics 1104, where the rays of light are emitted by a light source from a single side of the resultant laminated material. The internal cavity optics 1104 may be surface relief patterns to redirect the light as collimated light or another type of light.

FIG. 11b shows a side view of another illustrative resultant laminated material 1106 that includes example rays of light 1108 being redirected by internal cavity optics 1110. The internal cavity optics 1110 may be gratings to redirect the light as colored light or otherwise disperse the light onto an adjacent surface (e.g., a display). The internal cavity optics 1110 may also be a polarizer or other optical feature or pattern.

FIG. 11c shows a side view of yet another illustrative resultant laminated material 1112 that includes example rays of light 1114 being redirected by internal cavity optics 1116, where the rays of light are emitted by multiple light sources from either side of the resultant laminated material 104. The internal cavity optics may be surface relief patterns to redirect the light as collimated light or another type of light.

FIG. 11d shows a side view of an illustrative resultant laminated material 1118 having multiple layers. A first layer 1120 may include internal cavity optics that provide a polarizer, a second layer 1122 may include internal cavity optics that provide redirection of light form a lightguide, and a third layer 1124 of internal cavity optics may provide other optical effects (e.g., lens, incoupling, etc.). More or fewer layers may also be included in the resultant laminated material 1118, which may be created using the process described with reference to FIG. 5.

Other illustrative Implementations

In some embodiments, the internal cavity optics may be used to create lenses. Laminated lens film may form cavity coupling structures on a scale of micrometers to nanometers. Embossed/imprinted films can be laminated on the carrier medium to produce lens structures with multiple layer patterns. The optical patterns may be completely integrated/embedded and are thus protected from debris or damage. There are many applications for these lenses such as in halogen replacements, solar cell concentrators, and general lighting implementations.

Another illumination lens is an un-direct transmission element, which is a coupling light from the air medium that directs the light at predetermined angles. In some embodiments, some surfaces have reflectors (2D or 3D) and other surfaces have a coupling pattern (2D or 3D). An LED bar may be used to collimate light at least in a 2D horizontal direction. Another application is a light bar, rod or tube, in which the coupling structure or film is an outer surface or an inner surface for coupling and directing the light. In the tube solution, a reflector rod can be utilized in the center (inner part). This type of coupling film can be laminated and direct light for various angles (inside or outside). The structure may be volume integrated, which may keep the pattern free from defects. Grating lenses may also provide an improved efficiency over conventional Fresnel lenses due to having smaller features, which have much less back reflection than conventional larger patterns, and also because a location of the patterns on a bottom side. When the patterns are on the bottom side, there is less direct back reflection because the medium carrier is on the top side.

In accordance with some embodiments, the internal cavity optics may also be used in a film to provide collimated light, or otherwise referred to as “collimation film.” A laminated cavity coupling film may provide a more narrow illumination. Larger incident angles can be collimated for the narrow angle and small angles can be transmitted through this film without a noticeable efficiency drop. Optical patterns can be nearly invisible in a display solution. These patterns may also be integrated or embedded by lamination. Additionally a LCD can have this type film on the top side, which may result in a more narrow distribution of light. The LCD normally makes distribution a bit larger even when prism sheets are utilized in the backlight. The transparent film with the internal cavities may be utilized on the top side and provide a final distribution of light.

In various embodiments, the internal cavity optics may also be used as a polarizer. A grating polarizer or wire grid can be produced by roll-to-roll techniques discussed above or other manufacturing techniques. In some embodiments, basic profiles may be manufactured by curing, and then deposition coating may be performed by a higher refractive index by means of laser assisted deposition, automatic layer deposition (ALD), or other similar techniques. The laser can deposit many different materials. Orientated directional deposition (on side deposition, asymmetric) may be used. The grating profile can be binary, slanted, quadrate with different slanted surfaces, and so forth.

In some embodiments, the internal cavity optics may also be used for light incoupling. A flat ball lens bar, especially on a row is a unique solution, and may contain a 2D surface or a 3D surface, depending on a collimation axis. Principally one axis collimation is adequate. This optical solution may be produced separately or together with a lightguide. Manufacturing techniques may include injection molding, casting, laser cutting, and so forth.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method of manufacturing internal cavity optics, the method comprising:
coating a surface of film with lacquer;
embossing an optical pattern on the surface of the film that includes the lacquer;
curing the lacquer on the film;
laminating the surface having the optical pattern to another material to enclose the optical pattern between the film and the other material and create the internal cavity optics; and
curing the laminated surface to fuse the film and the other material.

2. The method as recited in claim 1, wherein the optical pattern is formed by a replication cylinder or stamp that includes a surface relief pattern having features that span between a micrometer and a nanometer.

3. The method as recited in claim 1, wherein the internal cavity optics are at least one of surface relief forms to redirect light or light management gratings to filter the light.

4. The method as recited in claim 1, wherein the embossing is performed by a roll-to-roll manufacturing process.

5. A method comprising:
creating optical cavities on a surface of a first transparent film, the optical cavities to include a shape that redirects or filters light when light from a light source is directed at the optical cavities;
laminating the first transparent film to a second transparent film to enclose the optical cavities between the first and second transparent films; and
curing the laminated first and second transparent films to fuse the first and second transparent films into a laminated film.

6. The method as recited in claim 5, wherein the creating the optical cavities is performed by at least one of embossing, lithography, micro-molding, or casting.

7. The method as recited in claim 5, further comprising attaching the laminated film to a lightguide or an electronic display to provide frontlighting or backlighting by redirecting light at the optical cavities and onto the electronic display.

8. The method as recited in claim 5, wherein the optical cavities, when enclosed between the first and second transparent films, are filled with air that provides low refractive index properties.

9. The method as recited in claim 5, wherein the curing the laminated first and second transparent films to fuse the first and second transparent creates the laminated film as a single piece of material that includes the optical cavities.

10. The method as recited in claim 5, wherein the creating the optical cavities includes embossing a pattern onto curable lacquer that is applied to the surface of the first transparent film.

11. The method as recited in claim 5, wherein the first transparent film is formed of at least one of a polymer, a elastomer, glass, or a ceramic and includes a thickness that is greater than a thickness of the second transparent film.

12. The method as recited in claim 5, wherein the laminated film is deployed as a front lightguide with a touch screen enabled display.

13. An internal cavity optical film comprising:
a first transparent film including optical cavities formed in at least one surface of the film; and
a second transparent film laminated to the first transparent film to enclose the optical cavities as internal cavity optics within a resultant transparent film, the internal cavity optics to redirect or filter light shone through the resultant transparent film.

14. The internal cavity optical film as recited in claim 13, further comprising a third transparent film including optical cavities formed on a surface that is laminated to the first transparent film or the second transparent film and that creates another layer of internal cavity optics within the resultant transparent film.

15. The internal cavity optical film as recited in claim 13, wherein the first and second transparent films are formed of one of a polymer or an elastomer.

16. The internal cavity optical film as recited in claim 13, wherein the internal cavity optics are at least one of surface relief forms or light management gratings.

17. The internal cavity optical film as recited in claim 13, wherein the internal cavity optics are inverted when deployed with a lightguide or an electronic display such that light exiting a vertex of the optical cavities is directed onto the electronic display.

18. The internal cavity optical film as recited in claim 13, wherein external surfaces of the first and second transparent films protect the internal cavity optics from contamination and damage.

19. A method of creating an internal cavity optical film comprising:
creating cavities on a surface of a transparent film; and
laminating the surface of the transparent film to a joiner material to enclose the cavities as internal cavity optics that redirect or filter light shone through the transparent film.

20. The method as recited in claim 19, wherein the transparent film is formed of a polymer or an elastomer and the joiner material is formed of glass or a ceramic.

21. The method as recited in claim 19, wherein the cavities are formed in a lacquer that is applied to the surface of the transparent film and then embossed with a pattern that creates the cavities.

22. The method as recited in claim 21, wherein the lacquer is one or more of a UV curable lacquer, a thermo curable lacquer, a moisture curable lacquer), or an electron curable lacquer, and further comprising curing the lacquer.

23. The method as recited in claim 19, further comprising laminating another transparent film to the transparent film or the joiner material to enclose additional optical cavities formed in the other transparent film within a resultant laminated material.

24. The method as recited in claim 19, wherein the creating the cavities is performed by a replication cylinder or stamp that embosses the cavities in the transparent film.

25. The method as recited in claim 24, wherein replication cylinder includes negative surface relief patterns that create the cavities and have features that span between a micrometer and a nanometer.
